(19) United States
(12) Patent Application Publication
(10) Pub. No.: US 2023/0372907 A1
(43) Pub. Date: Nov. 23, 2023

(54) METHOD FOR PRODUCING EXHAUST GAS PURIFICATION MATERIAL AND METHOD FOR MANUFACTURING EXHAUST GAS PURIFICATION DEVICE

(71) Applicants: Takahiro NISHIO, Miyoshi-shi (JP); Shogo SHIRAKAWA, Toyota-shi (JP); Nobuyuki TAKAGI, Toyota-shi (JP); Tomomasa AIKAWA, Fukuroi-shi (JP); Hiroki NIHASHI, Hamamatsu-shi (JP); Takahiro NOGUCHI, Hamamatsu-shi (JP)

(72) Inventors: Takahiro NISHIO, Miyoshi-shi (JP); Shogo SHIRAKAWA, Toyota-shi (JP); Nobuyuki TAKAGI, Toyota-shi (JP); Tomomasa AIKAWA, Fukuroi-shi (JP); Hiroki NIHASHI, Hamamatsu-shi (JP); Takahiro NOGUCHI, Hamamatsu-shi (JP)

(73) Assignees: TOYOTA JIDOSHA KABUSHIKI KAISHA, Toyota-shi (JP); CATALER CORPORATION, Kakegawa-shi (JP)

(21) Appl. No.: 18/318,099

(22) Filed: May 16, 2023

(30) Foreign Application Priority Data
May 23, 2022 (JP) 2022-083679

(51) Int. Cl. B01J 23/46; B01J 37/02; B01J 37/08; B01J 35/02; B01D 53/94

(52) U.S. Cl. CPC B01J 23/464; B01J 37/0201; B01J 37/0236; B01J 37/08; B01J 35/023; B01D 53/94; B01D 2255/1025; B01D 2258/01

(57) ABSTRACT

Provided are a method for producing an exhaust gas purification material and a method for manufacturing an exhaust gas purification device that allow efficient removal of a harmful component even after exposure to a high temperature environment. The method for producing the exhaust gas purification material includes the steps, in this order, of: (a) impregnating a metal oxide carrier with a rhodium compound solution; (b) drying the metal oxide carrier impregnated with the rhodium compound solution to obtain a rhodium-containing catalyst containing the metal oxide carrier and rhodium particles supported on the metal oxide carrier; (c) heating the rhodium-containing catalyst at a temperature within a range from 700° C. to 900° C. under an inert atmosphere; and (d) mixing the rhodium-containing catalyst with a material having a basicity higher than a basicity of the metal oxide carrier.

### CROSS REFERENCE TO RELATED APPLICATIONS

The present application claims priority from Japanese patent application JP 2022-083679 filed on May 23, 2022, the entire content of which is hereby incorporated by reference into this application.

### BACKGROUND

### Technical Field

The present disclosure relates to a method for producing an exhaust gas purification material and a method for manufacturing an exhaust gas purification device.

### Background Art

An exhaust gas discharged from an internal combustion engine used in a vehicle, such as an automobile, contains a harmful component, such as carbon monoxide (CO), hydrocarbon (HC), and nitrogen oxide (NOx). Regulations on emission amounts of these harmful components have been tightened year by year. To remove these harmful components, a noble metal, such as platinum (Pt), palladium (Pd), and rhodium (Rh), has been used as a catalyst.

Meanwhile, from an aspect of resource risk, reduction in usage of the noble metal has been demanded. As one method for reducing the usage of the noble metal in an exhaust gas purification device, there has been known a method in which a noble metal is supported on a carrier in a form of fine particles. For example, JP 2016-147256 A discloses a method for producing an exhaust gas purification material that includes a step of supporting noble metal particles on an oxide carrier to produce a noble metal supported catalyst and a step of performing a heating process on the noble metal supported catalyst under a reducing atmosphere to control sizes of the noble metal particles within a predetermined range.

### SUMMARY

Through intensive studies, the inventors have found that use of an exhaust gas purification material obtained by the production method disclosed in JP 2016-147256. A under a high temperature environment leads to decrease of a catalytic activity in some cases.

The present disclosure provides a method for producing an exhaust gas purification material and a method for manufacturing an exhaust gas purification device that allow efficient removal of a harmful component even after exposure to a high temperature environment.

The present disclosure provides the following aspects, for example.

1. A method for producing an exhaust gas purification material, the method comprising the steps, in this order, of:
(a) impregnating a metal oxide carrier with a rhodium compound solution;
(b) drying the metal oxide carrier impregnated with the rhodium compound solution to obtain a rhodium-containing catalyst containing the metal oxide carrier and rhodium particles supported on the metal oxide carrier;
(c) heating the rhodium-containing catalyst at a temperature within a range from 700° C. to 900° C. under an inert atmosphere; and
(d) mixing the rhodium-containing catalyst with a material having a basicity higher than a basicity of the metal oxide carrier.
   2. The method according to Aspect 1,
wherein in the rhodium-containing catalyst after the step (c), a mean of a particle size distribution of the rhodium particles is from 1.5 nm to 18 nm and a standard deviation of the particle size distribution less than 1.6 nm.
   3. The method according to Aspect 2,
wherein in the rhodium-containing catalyst after the step (c), the mean of the particle size distribution of the rhodium particles is from 4 nm to 14 nm.
   4. The method according to Aspect 2,
wherein in the rhodium-containing catalyst after the step (c), the mean of the particle size distribution of the rhodium particles is from 2 nm to 8 nm.
   5. The method according to any one of Aspects 1 to 4,
wherein the rhodium-containing catalyst contains the rhodium particles in an amount of 0.01 wt % to 2 wt % based on a total weight of the metal oxide carrier and the rhodium particles.
   6. The method according to any one of Aspects 1 to 5,
wherein the metal oxide carrier is an oxide containing zirconia as a main component, a composite oxide containing zirconia and alumina as main components, or a composite oxide containing zirconia, alumina, and ceria as main components.
   7. The method according to any one of Aspects 1 to 6,
wherein the metal oxide carrier is a composite oxide containing zirconia, alumina, and ceria as main components, and the material having the basicity higher than the basicity of the metal oxide carrier is a composite oxide containing ceria and zirconia as main components.
   8. The method according to any one of Aspects 1 to 7,
wherein the inert atmosphere is a nitrogen atmosphere.
   9. A method for manufacturing an exhaust gas purification device, the method comprising:
obtaining the exhaust gas purification material by the method according to any one of Aspects 1 to 8; and
disposing the exhaust gas purification material on a substrate.

The exhaust gas purification material and the exhaust gas purification device manufactured by the methods of the present disclosure allow efficient removal of a harmful component even after exposure to a high temperature environment.

### DETAILED DESCRIPTION

The following will describe embodiments of the present disclosure with reference to the drawings as appropriate. The present disclosure is not limited to the following embodiments, and can be subjected to various kinds of changes in design without departing from the spirit of the present disclosure described in the claims. A numerical range expressed herein using the term “to” includes respective values described before and after the term “to” as a lower limit value and an upper limit value. Upper limit values and lower limit values in numerical ranges disclosed herein can be arbitrarily combined.

### (1) Exhaust Gas Purification Material

First, an exhaust gas purification material produced by a method according to the embodiment will be described. The exhaust gas purification material is a mixture of an Rh-containing catalyst containing a metal oxide carrier and Rh particles supported on the metal oxide carrier, and a material having a basicity higher than that of the metal oxide carrier.

Examples of the metal oxide carrier include an oxide of at least one metal selected from the group consisting of metals of the group 3, the group 4, and the group 13 in the periodic table of elements and lanthanoid-based metals. When the metal oxide carrier contains two or more metal elements, the metal oxide carrier may be a mixture of oxides of the two or more metal elements, may be a composite oxide containing the two or more metal elements, or may be a mixture of an oxide of at least one metal element and at least one composite oxide.

For example, the metal oxide carrier may be an oxide of at least one metal selected from the group consisting of scandium (Sc), yttrium (Y), lanthanum (La), cerium (Ce), neodymium (Nd), samarium (Sm), europium (Eu), lutetium (Lu), titanium (Ti), zirconium (Zr), and aluminum (Al), an oxide of at least one metal selected from the group consisting of Y, La, Ce, Ti, Zr and Al in some embodiments, and an oxide of at least one metal selected from the group consisting of Al, Ce, and Zr in some embodiments. The metal oxide carrier may be an oxide containing zirconia (ZrO₂) as the main component, may be an Al—Zr-based composite oxide, which is a composite oxide containing zirconia and alumina (Al₂O₃) as the main components, or may be an Al—Ce—Zr-based composite oxide, which is a composite oxide containing zirconia, alumina, and ceria (CeO₂) as the main components. The zirconia may serve to maintain catalytic activity of the Rh particles. The ceria may serve as an Oxygen Storage Capacity (OSC) material which stores oxygen in an atmosphere under an oxygen excess atmosphere and discharges oxygen under an oxygen deficient atmosphere. The alumina may serve to control diffusion of the Rh particles. The metal oxide carrier may be particles of a composite oxide containing alumina, ceria, and zirconia as the main component, and further containing at least one of yttria (Y₂O₃), lanthana (La₂O₃), neodymia (Nd₂O₃), or praseodymia (Pr₆O₁₁). Yttria, lanthana, neodymia, and praseodymia improve heat resistance of the composite oxide. Note that the phrase “contain as the main component(s)” herein means that the content of the referred component is 50 wt % or more, 70 wt % or more, 80 wt % or more, or 90 wt % or more of the total weight. When a plurality of main components are present, that phrase means that the sum of the contents of the referred components is 50 wt % or more, 70 wt % or more, 80 wt % or more, or 90 wt % or more.

The metal oxide carrier may be particulate, and may have any particle size depending on its purpose.

The Rh particles supported on the metal oxide carrier function as a catalyst to remove harmful components contained in an exhaust gas. A mean of a particle size distribution of the Rh particles may be within the range from 1.5 nm to 18 nm. Generally, the smaller the sizes of the Rh particles are, the larger specific surface area the Rh particles have, and therefore the higher catalyst performance the Rh particles exhibit. However, the Rh particle having the excessively small particle size tends to coarsen due to Ostwald ripening and aggregation etc. under a high temperature environment, causing deterioration of catalyst performance. When the mean of the particle size distribution of the Rh particles is 1.5 nm or more, the coarsening of the Rh particles under a high temperature environment is controlled, and thus the deterioration of the catalyst performance is reduced or prevented. The Rh particles of which particle size distribution has a mean of 18 nm or less have a sufficiently large specific surface area, and therefore can provide high catalyst performance. The mean of the particle size distribution of the Rh particles may be within the range from 3 nm to 17 nm or within the range from 4 nm to 14 nm. The mean of the particle size distribution of the Rh particles may be within the range from 2 nm to 8 nm.

Additionally, a standard deviation of the particle size distribution of the Rh particles may be less than 1.6 nm. As shown in Reference Examples described later, the standard deviation of the particle size distribution of the Rh particles of less than 1.6 nm allows efficient removal of the harmful components even after the exhaust gas purification material is exposed to a high temperature environment. The Rh particles of which particle size distribution has a standard deviation of less than 1.6 nm include a small number of coarse Rh particles and a small number of fine Rh particles likely to coarsen under a high temperature environment. Therefore, such Rh particles can have the sufficiently large specific surface area even after the exhaust gas purification material is exposed to a high temperature environment, and as a result, the high catalyst performance can be provided. The standard deviation of the particle size distribution of the Rh particles may be 1 nm or less.

The particle size distribution of the Rh particles herein is a particle size distribution on the number basis (i.e., a number-weighted particle size distribution) determined by measuring a projected area equivalent circle diameter of 50 or more of the Rh particles using an image obtained with a transmission electron microscope (TEM).

The amount of the supported Rh particles, that is, the proportion of the Rh particles based on the total weight of the metal oxide carrier and the Rh particles, may be within the range from 0.01 wt % to 2 wt %. The proportion of the Rh particles of 0.01 wt % or more allows satisfactory removal of the harmful components from the exhaust gas by virtue of the sufficient amount of the Rh particles present. The proportion of the Rh particles of 2 wt % or less allows reducing the amount of Rh used, and additionally allows exhibiting sufficient durability against a high temperature because coarsening of the Rh particles under a high temperature environment is avoided or controlled owing to sparseness of the Rh particles supported on the metal oxide carrier. The proportion of the Rh particles based on the total weight of the metal oxide carrier and the Rh particles may be within the range from 0.2 wt % to 1.8 wt %.

The material having a basicity higher than that of the metal oxide carrier (hereinafter referred to as a “high basicity material” as appropriate) may be particulate. The high basicity material may be, for example, a material functioning as an OSC material. For example, ceria and a composite oxide containing ceria (for example, a composite oxide containing ceria as the main component, a Ce—Zr-based composite oxide, which is a composite oxide containing ceria and zirconia as the main components, and an Al—Ce—Zr-based composite oxide, which is a composite oxide containing alumina, ceria, and zirconia as the main components) can function as the OSC material. Especially, the Ce—Zr-based composite oxide may be used in some embodiments because the Ce—Zr-based composite oxide has high oxygen storage capacity and are relatively inexpensive. In addition to the main component(s), the composite oxide containing ceria may further contain at least one of praseodymia, lanthana, yttria, or neodymia as an additive(s), and the additives may form a composite oxide together with the main component(s). When the exhaust gas purification material contains the material that functions as the OSC material, the exhaust gas purification material can exhibit satisfactory exhaust gas purification performance under both of an oxygen excess atmosphere and an oxygen deficient atmosphere.

The high basicity material may be particulate, and may have any particle size depending on its purpose.

“A material having a basicity higher than that of the metal oxide carrier” is herein defined as a material having average electronegativity smaller than average electronegativity of the metal oxide carrier. The “average electronegativity” is an average of Pauling electronegativities (hereinafter simply referred to as “electronegativity”) of constituent elements weighted by the numbers of the respective elements per unit weight. For example, the average electronegativity of ACZ particles which are composite oxide particles containing Al₂O₃, CeO₂, ZrO₂, La₂O₃, Y₂O₃, and Nd₂O₃ by the following weight fractions, Al₂O₃: 30 wt %, CeO₂: 20 wt %, ZrO₂: 44 wt %, La₂O₃: 2 wt %, Y₂O₃: 2 wt %, and Nd₂O₃: 2 wt%, is calculated as follows.

Average Electronegativity of ACZ Particles=electronegativity of Al×weight fraction of Al₂O₃/formula weight of Al₂O₃×2+electronegativity of Ce×weight fraction of CeO₂/formula weight of CeO₂+electronegativity of Zr×weight fraction of ZrO₂/formula weight of ZrO₂+electronegativity of La×weight fraction of La₂O₃/formula weight of La₂O₃×2+electronegativity of Y×weight fraction of Y₂O₃/formula weight of Y₂O₃×2+electronegativity of Nd×weight fraction of Nd₂O₃/formula weight of Nd₂O₃×2+electronegativity of O×(weight fraction of Al₂O₃/formula weight of Al₂O₃×3+weight fraction of CeO₂/formula weight of CeO₂×2+weight fraction of ZrO₂/formula weight of ZrO₂×2+weight fraction of La₂O₃/formula weight of La₂O₃×3+weight fraction of Y₂O₃/formula weight of Y₂O₃×3+weight fraction of Nd₂O₃/formula weight of Nd₂O₃×3)=1.61×0.3/101.9×2+1.12×0.2/172.1+1.33×0.44/123.2+1.10×0.02/325.8×2+1.22×0.02/225.8×2+1.14×0.02/336.4×2+3.44×(0.3/101.9×3+0.2/172.1×2+0.44/123.2×2+0.02/325.8×3+0.02/225.8×3+0.02/336.4×3)=0.081

The average electronegativity of CZ particles which are composite oxide particles containing CeO₂, ZrO₂, and Pr₆O₁₁ by the following weight fractions, CeO₂: 51.4 wt %, ZrO₂: 45.6 wt %, and Pr₆O₁₁: 3.0 wt %, is calculated as follows.

Average Electronegativity of CZ Particles=electronegativity of Ce×weight fraction of CeO₂/formula weight of CeO₂+electronegativity of Zr×weight fraction of ZrO₂/formula weight of ZrO₂+electronegativity of Pr×weight fraction of Pr₆O₁₁/formula weight of Pr₆O₁₁×6+electronegativity of O×(weight fraction of CeO₂/formula weight of CeO₂×2+weight fraction of ZrO₂/formula weight of ZrO₂×2+weight fraction of Pr₆O₁₁/formula weight of Pr₆O₁₁×11)=1.12×0.514/172.1+1.33×0.456/123.2+1.13×0.03/1021.4×6+3.44×(0.514/172.1×2+0.456/123.2×2+0.03/1021.4×11)=0.056

From the above-described calculation, the CZ particles having the aforementioned composition have the average electronegativity smaller than that of the ACZ particles having the aforementioned composition, and thus, have the basicity higher than that of the ACZ particles having the aforementioned composition.

### (2) Method for Producing Exhaust Gas Purification Material

The method for producing the above-described exhaust gas purification material includes: impregnating a metal oxide carrier with a rhodium compound solution; (Step S1); drying the metal oxide carrier impregnated with the rhodium compound solution to obtain an Rh-containing catalyst containing the metal oxide carrier and Rh particles supported on the metal oxide carrier (Step S2); heating the Rh-containing catalyst at a temperature within a range from 700° C. to 900° C. under an inert atmosphere (Step S3); and mixing the Rh-containing catalyst with a high basicity material (Step S4) in the order. The respective processes will be described in order.

First, the metal oxide carrier is impregnated with the rhodium compound solution (Step S1). Examples of the rhodium compound solution include an aqueous solution of rhodium hydroxide and an aqueous solution of rhodium nitrate. The impregnation method is not specifically limited. For example, adding the metal oxide carrier and the rhodium compound solution to distilled water while stirring the distilled water allows the metal oxide carrier to be impregnated with the rhodium compound solution.

Next, the metal oxide carrier impregnated with the rhodium compound solution is dried (Step S2). This allows obtaining the Rh-containing catalyst containing the metal oxide carrier and the Rh particles supported on the metal oxide carrier. As appropriate, baking may be performed after drying. In the Rh-containing catalyst, the proportion of the Rh particles based on the total weight of the Rh-containing catalyst (that is, the sum of weights of the metal oxide carrier and the Rh particles) may be within the range from 0.01 wt % to 2 wt % and in particular from 0.2 wt % to 1.8 wt %.

The Rh-containing catalyst is heated to a temperature within the range from 700° C. to 900° C. under an inert atmosphere (Step S3). Examples of the inert atmosphere include a nitrogen atmosphere and an argon atmosphere. The heating period may be any appropriate length of time, and, for example, may be from one to eight hours.

Heating under the inert atmosphere allows appropriately controlling the mean and the standard deviation of the particle size distribution of the Rh particles in the Rh-containing catalyst. Specifically, the mean of the particle size distribution of the Rh particles can be within the range from 1.5 nm to 18 nm, within the range from 3 nm to 17 nm, or within the range from 4 nm to 14 nm, or within the range from 2 nm to 8 nm, and the standard deviation of the particle size distribution of the Rh particles can be less than 1.6 nm or 1 nm or less.

Note that as described in Examples described later, it is difficult to obtain the particle size distribution as described above through baking under a reducing atmosphere such as a hydrogen atmosphere because the Rh particles cannot be sufficiently enlarged under a reducing atmosphere. It should also be noted that heating under an oxidation atmosphere, such as an air atmosphere, causes dissolution of the Rh particles into the metal oxide carrier to form a solid solution, and thus the Rh particles on the metal oxide carrier surface decrease.

Afterwards, the Rh-containing catalyst is mixed with the high basicity material (Step S4). Although the mixture method is not specifically limited, for example, the Rh-containing catalyst and the high basicity material may be mixed while pulverized. This allows obtaining a powdery exhaust gas purification material. The obtained powdery exhaust gas purification material may be molded in any shape, such as a pellet shape, by press molding or the like.

Generally, exposing fine Rh particles having several nm of particle sizes to a high temperature (for example, 1000° C. or more) environment causes formation of the Rh particles with the increased particle sizes by Ostwald ripening. According to the present inventors, Rh on the high basicity material is more stable in a state of trivalent (i.e., an oxide state) than in a state of zero valence (i.e., a metal state). Rh in the oxide state is easily vaporized to move. Therefore, collision frequency of Rh atoms is high on the high basicity material, thus the coarse Rh particles are more likely to be formed on the high basicity material than on the metal oxide carrier. The use of the exhaust gas purification material containing the Rh-containing catalyst and the high basicity material in the high temperature environment causes the Rh atoms in the fine Rh particles on the metal oxide carrier to move onto the high basicity material to form the coarse Rh particles on the high basicity material. Therefore, when the Rh-containing catalyst is used together with the high basicity material, compared with the case in which the Rh-containing catalyst is used alone, it is more likely that the Rh particles coarsen and purification performance decreases. However, as described above, in the production method according to the embodiment, the mean and the standard deviation of the particle size distribution of the Rh particles on the metal oxide carrier are controlled by heating under an inert atmosphere, thereby reducing the number of excessively small Rh particles. This avoids or controls the movement of the Rh atoms to the high basicity material and formation of the coarse Rh particles due to Ostwald ripening when the exhaust gas purification material is exposed to the high temperature environment. Therefore, the exhaust gas purification material produced by the production method according to the embodiment has exhaust gas purification performance that is less likely to decrease under a high temperature environment.

Additionally, in the production method according to the embodiment, the Rh particles with the appropriately controlled particle sizes are formed through the simple process with the impregnation method using the rhodium compound solution and the heating treatment under the inert atmosphere. Therefore, the production method according to the embodiment is high in production efficiency and suitable for mass-production.

(3) Method for Manufacturing Exhaust Gas Purification Device

The exhaust gas purification device can be manufactured by disposing the above-described exhaust gas purification material on the substrate.

The exhaust gas purification material may be disposed on the substrate together with, for example, a binder and an additive.

Although the substrate is not specifically limited, a monolith substrate having a honeycomb structure, for example, can be used. The substrate may be made from a ceramic material having high heat resistance, such as cordierite (2MgO·2Al₂O₃·5SiO₂), alumina, zirconia, and silicon carbide, and a metal material made from a metal foil, such as a stainless-steel foil. From the aspect of cost, the substrate may be made from cordierite in some embodiments.

When the substrate is a porous body having a plurality of pores, the exhaust gas purification material may be disposed on an inner surface defining the pores of the substrate. That is, “disposed on the substrate” herein includes both of being disposed on an outer surface of the substrate and being disposed on the inner surface of the substrate.

The exhaust gas purification material can be disposed on the substrate through the following illustrative procedure. First, a slurry containing the exhaust gas purification material is prepared. The slurry may further contain a binder, an additive, and the like. Properties of the slurry, such as viscosity and a particle diameter of a solid component, may be adjusted as appropriate. The prepared slurry is applied over a predetermined region of the substrate. For example, the predetermined region of the substrate is immersed in the slurry, and after a predetermined period has passed, the substrate is taken out of the slurry, thus allowing the slurry to be applied over the predetermined region of the substrate. Alternatively, the slurry may be poured into the substrate, and blown with a blower to be spread and applied over the substrate. Next, the slurry is dried and baked at a predetermined temperature for a predetermined period. Thus, the exhaust gas purification material is disposed on the substrate.

The exhaust gas purification device according to the embodiment is applicable to various kinds of vehicles including internal combustion engines.

### EXAMPLES

The following will specifically describe the present disclosure with the examples, but the present disclosure is not limited to the examples.

### Examples 1 to 5

### (1) Preparing Sample

As the metal oxide carrier, composite oxide particles containing Al₂O₃, CeO₂, and ZrO₂ as the main components and further containing La₂O₃, Y₂O₃, and Nd₂O₃ were prepared. The composite oxide particles containing Al₂O₃, CeO₂, and ZrO₂ as the main components and further containing La₂O₃, Y₂O₃, and Nd₂O₃ are hereinafter referred to as “ACZ particle” as appropriate. Weight fractions of the respective components in the ACZ particles were Al₂O₃: 30 wt %, CeO₂: 20 wt %, ZrO₂: 44 wt %, La₂O₃: 2 wt %, Y₂O₃: 2 wt %, and Nd₂O₃: 2 wt %)

To stirred distilled water, 10 g of the ACZ particles and 8.0 g of a rhodium hydroxide aqueous solution (concentration: 0.5 wt %) were added in order of mention, and were stirred for 10 minutes. The obtained mixture was dried, and baking was performed by heating in an electric furnace under an air atmosphere for two hours at 500° C. Thus, an Rh-containing catalyst containing the ACZ particles and rhodium (Rh) particles supported on the ACZ particles was obtained. The Rh-containing catalyst contained the Rh particles in an amount of 0.34 wt % based on the total weight of the ACZ particles and the Rh particles.

The Rh-containing catalysts were heated under a nitrogen atmosphere for five hours at the temperatures described in Table 1. After heating, the Rh-containing catalyst was observed with a Transmission Electron Microscope (TEM) to determine the particle size distribution of the Rh particles (initial Rh particles) supported on the ACZ particles. Table 1 shows the mean and the standard deviation of the particle size distribution of the initial Rh particles.

To the Rh-containing catalyst after heating, 10 g of composite oxide particles containing CeO₂ and ZrO₂ as the main components and further containing Pr₆O₁₁ were added, and pulverized and mixed in a mortar. The composite oxide particles containing CeO₂ and ZrO₂ as the main components and further containing Pr₆O₁₁ are hereinafter referred to as “CZ particles” as appropriate. Weight fractions of the respective components in the CZ particles were CeO₂: 51.4 wt %, ZrO₂: 45.6 wt %, and Pr₆O₁₁: 3.0 wt %). 2 g of the obtained powder was weighed, and molded into a pellet.

### (2) Aging Process and Measurement of Average Particle Size of Rh Particles after Aging Process

While heated to 1100° C., the pellet was exposed alternately to a stoichiometric air-fuel mixture (air-fuel ratio A/F=14.6) and a lean air-fuel mixture containing excess oxygen (A/F>14.6) with a time ratio of 1:1 at a fixed cycle of time for five hours. Afterwards, the average particle sizes of the Rh particles in the pellets of Example 2 and Example 4 were determined by carbon monoxide pulse method. Table 1 shows the results.

### (3) Exhaust Gas Purification Performance Evaluation

While the gas having the composition described in Table 2 was allowed to flow to the pellet after the aging process at the flow rate of 15 L/minute, the pellet was heated to 600° C. and maintained for five minutes and then the pellet was allowed to be cooled down to 150° C. Afterwards, while the flow of the gas was continued, the temperature of the pellet was increased up to 600° C. at a rate of 20° C./minute, and “NOx-T50”, which is a temperature of the pellet when 50% of NOx in the gas was removed, was measured. The results were as shown in Table 1.

### Comparative Example 1

Except that the Rh-containing catalyst was not heated under the nitrogen atmosphere, the pellet was manufactured similarly to Example 1. The mean and the standard deviation of the particle size distribution of the initial Rh particles were as shown in Table 1. Similarly to Example 1, the aging process and the exhaust gas purification performance evaluation of the pellet were performed. Table 1 shows the result.

### Comparative Examples 2 and 3

Except that the heating temperature of the Rh-containing catalyst under the nitrogen atmosphere was as described in Table 1, the pellet was manufactured similarly to Example 1. The mean and the standard deviation of the particle size distribution of the initial Rh particles were as shown in Table 1. Similarly to Example 1, the aging process and the exhaust gas purification performance evaluation of the pellet were performed. Table 1 shows the result.

### Comparative Example 4

Except that the Rh-containing catalyst was heated under an air atmosphere instead of the nitrogen atmosphere, the pellet was manufactured similarly to Example 3. Observation of the Rh-containing catalyst after heating was performed with the TEM, but the Rh particles supported on the ACZ particles could not be found. It is considered that Rh was dissolved in the ACZ particles to form a solid solution due to heating under the air atmosphere. Similarly to Example 1, the aging process and the exhaust gas purification performance evaluation of the pellet were performed. Table 1 shows the result.

### Comparative Example 5

Except that the Rh-containing catalyst was heated under a hydrogen atmosphere instead of the nitrogen atmosphere, the pellet was manufactured similarly to Example 3. The mean and the standard deviation of the particle size distribution of the initial Rh particles were as shown in Table 1. Similarly to Example 1, the aging process of the pellet and the exhaust gas purification performance evaluation of the pellet were performed. Table 1 shows the result.

### Comparative Example 6

Except that the ACZ particles were used instead of the CZ particles, the pellet was manufactured similarly to Example 4. Similarly to Example 1, the aging process of the pellet and the exhaust gas purification performance evaluation of the pellet were performed. Table 1 shows the result.

### Comparative Example 7

Except that the Rh-containing catalyst was not heated under the nitrogen atmosphere, the pellet was manufactured similarly to Comparative Example 6. Similarly to Example 1, the aging process and the exhaust gas purification performance evaluation of the pellet were performed. Table 1 shows the result.

Through comparison between NOx-T50s of Examples 1 to 5 and Comparative Examples 1 to 5, it was found that heating of the Rh-containing catalyst under the nitrogen atmosphere at the temperature within the range from 700° C. to 900° C. improved NOx reducing performance. As shown in Table 1, in Examples 1 to 5, heating at the temperature within the range from 700° C. to 900° C. under the nitrogen atmosphere allowed the mean of the particle size distribution of the Rh particles to be within the range from 1.5 nm to 18 nm and the standard deviation of the particle size distribution to be less than 1.6 nm. This would have prevented or controlled coarsening of the Rh particles and reducing of the specific surface area of the Rh particles during the aging process, and as a result, the high NOx reducing performance was obtained. Especially, comparison between NOx-T50s of Example 2 and Example 4 indicates that heating at 850° C. under the nitrogen atmosphere brought more excellent NOx reducing performance than that brought by heating at 750° C. under the nitrogen atmosphere. It is considered that the cause of the higher NOx reducing performance in Example 4 where the heating temperature was 850° C. was that the average particle size of the Rh particles after the aging process was smaller than that in Example 2, and the Rh particles had the larger specific surface area than that in Example 2. Additionally, comparison between NOx-T50s of Example 3 and Comparative Examples 4 and 5 indicates that the Rh-containing catalyst needs to be heated under the nitrogen atmosphere for appropriate control of the particle size distribution of the Rh particles.

The NOx-T50 of Comparative Example 6 was higher than the NOx-T50 of Comparative Example 7. This suggests that heating under the nitrogen atmosphere in Comparative Example 6 did not bring improvement in NOx reducing performance. It is considered that, in Comparative Examples 6 and 7, since the pellet did not contain a material having a basicity higher than that of the ACZ particles used as the catalyst carrier, remarkable coarsening of the Rh particles did not occur in the aging process even without intentionally controlling the particle size distribution of the Rh particles.

TABLE 1

| | | | | Standard | | |
|---|---|---|---|---|---|---|
| | | | Mean of | Deviation of | Average | |
| | | | Particle Size | Particle Size | Particle Size of | |
| | Atmosphere | Heating | Distribution of | Distribution of | Rh Particles | |
| | during | Temperature | Initial Rh | Initial Rh | after Aging | NOx-T50 |
| | Heating | [° C.] | Particles [nm] | Particles [nm] | [nm] | [° C.] |
| Comparative | — | — | 0.70 | 0.23 | | 345.1 |
| Example 1 | | | | | | |
| Comparative | Nitrogen | 600 | 1.22 | 0.37 | | 330.3 |
| Example 2 | | | | | | |
| Example 1 | Nitrogen | 700 | 2.20 | 0.89 | | 320.4 |
| Example 2 | Nitrogen | 750 | 3.36 | 1.16 | 9.55 | 310.2 |
| Example 3 | Nitrogen | 800 | 4.32 | 1.22 | | 308.2 |
| Example 4 | Nitrogen | 850 | 5.49 | 1.49 | 9.21 | 299.8 |
| Example 5 | Nitrogen | 900 | 7.85 | 1.59 | | 315.2 |
| Comparative | Nitrogen | 1000 | 10.02 | 2.385 | | 328.5 |
| Example 3 | | | | | | |
| Comparative | Air | 800 | — | — | | 393.6 |
| Example 4 | | | | | | |
| Comparative | Hydrogen | 800 | 1.40 | 0.36 | | 327.9 |
| Example 5 | | | | | | |
| Comparative | Nitrogen | 850 | | | | 290.9 |
| Example 6 | | | | | | |
| Comparative | — | — | | | | 276.2 |
| Example 7 | | | | | | |

TABLE 2

| Component | Proportion | |
|---|---|---|
| CO | 0.52 | vol % |
| O₂ | 0.50 | vol % |
| C₃H₆ | 3000 | ppmC |
| NO | 0.32 | vol % |
| CO₂ | 14 | vol % |
| H₂ | 3 | vol % |

| | |
|---|---|
| N₂ | Balance |

The following Reference Examples show results of experiment conducted to determine the particle size distribution of the initial Rh particles appropriate for avoiding or controlling the decrease in exhaust gas purification performance under a high temperature environment. In the Reference Examples, the Rh particles are supported on the ACZ particles by a method different from the embodiments described above. However, it should be understood that the particle size distribution of the initial Rh particles determined as appropriate on the basis of the Reference Examples can avoid or control the decrease in exhaust gas purification performance under a high temperature environment as well even when the exhaust gas purification material is produced by the method according to the embodiments.

### Reference Example 1

### (1) Preparing Sample

Polyvinylpyrrolidone and rhodium chloride were dissolved in ethylene glycol. Sodium hydroxide was added to the obtained solution. The solution was heated to 200° C. overnight. Thus, a rhodium particle dispersion (Rh particle dispersion) was obtained.

The Rh particle dispersion and the ACZ particles were added to distilled water, and the obtained mixture was dried by heating while being stirred. The obtained particles were placed in a dryer maintained at 120° C. for two hours to further remove water content, and then the obtained particles were baked by heating in an electric furnace under the air atmosphere at 500° C. for two hours.

The particles after baking were observed with TEM and it was confirmed that the Rh particles were supported on the ACZ particles. Additionally, based on the TEM image, the particle size distribution of the Rh particles (the initial Rh particles) supported on the ACZ particles was determined. Table 3 shows the mean and the standard deviation of the particle size distribution of the initial Rh particles. The weight proportion of the Rh particles (that is, the weight proportion of the Rh particles based on the total weight of the ACZ particles and the Rh particles) in the baked particles was as shown in Table 3.

To the baked particles, composite oxide particles of CeO₂ and ZrO₂ having the same weight as the baked particles were added, and pulverized and mixed in a mortar. Hereinafter, the composite oxide particles of CeO₂ and ZrO₂ in which weight fractions of the respective components were CeO₂: 46 wt % and ZrO₂: 54 wt % are referred to as “CZ-2 particles” as appropriate. 2 g of the obtained powder was weighed and molded into a pellet.

### (2) Measurement of Average Particle Size of Rh Particles After Aging Process

Similarly to Example 2, the average particle size of the Rh particles after the aging process of the pellet was measured. Table 3 shows the result.

### (3) Exhaust Gas Purification Performance Evaluation

Similarly to Example 1, the exhaust gas purification performance of the pellet after the aging process was measured. The result was as shown in Table 3.

### Reference Example 2

Except that the rhodium nitrate aqueous solution was used instead of the Rh particle dispersion, the pellet was manufactured similarly to Reference Example 1. The mean and the standard deviation of the particle size distribution of the initial Rh particles and the weight proportion of the Rh particles in the baked particles were as shown in Table 3.

Similarly to Reference Example 1, the average particle size of the Rh particles after the aging process was measured and the exhaust gas purification performance was evaluated. Table 3 shows the results.

### Reference Example 3

Except that an Rh particle dispersion prepared as follow was used instead of the Rh particle dispersion prepared in Reference Example 1, the pellet was manufactured similarly to Reference Example 1. 0.2 g of rhodium nitrate (III) was dissolved into 50 mL of ion exchanged water to prepare a rhodium nitrate aqueous solution (pH 1.0). Additionally, a 175 g/L tetraethylammonium hydroxide aqueous solution (pH 14) was prepared. Using a reactor (micro reactor) having two flat plates as a clearance adjustment member, the rhodium nitrate aqueous solution and the tetraethylammonium hydroxide aqueous solution were reacted with each other. Specifically, the rhodium nitrate aqueous solution and the tetraethylammonium hydroxide aqueous solution with a molar ratio of tetraethylammonium hydroxide to rhodium nitrate of 18:1 were introduced to a reaction field with a clearance of 10 μm to react with each other, thereby preparing the Rh particle dispersion. The resulting Rh particle dispersion had a pH of 14.

The mean and the standard deviation of the particle size distribution of the initial Rh particles and the weight proportion of the Rh particles in the baked particles were as shown in Table 3.

Similarly to Reference Example 1, the average particle size of the Rh particles after the aging process was measured and the exhaust gas purification performance was evaluated. Table 3 shows the results.

### Reference Example 4

Except that the amount of sodium hydroxide used for preparation of the Rh particle dispersion was changed, the pellet was manufactured similarly to Reference Example 1. The mean and the standard deviation of the particle size distribution of the initial Rh particles and the weight proportion of the Rh particles in the baked particles were as shown in Table 3.

Similarly to Reference Example 1, the average particle size of the Rh particles after the aging process was measured and the exhaust gas purification performance was evaluated. Table 3 shows the results.

### Reference Examples 5 to 7

Except that the amount of sodium hydroxide used for preparation of the Rh particle dispersion was changed, the pellet was manufactured similarly to Reference Example 1. The mean and the standard deviation of the particle size distribution of the initial Rh particles and the weight proportion of the Rh particles in the baked particles were as shown in Table 3.

Similarly to Reference Example 1, the exhaust gas purification performance of the pellet after the aging process was evaluated. Table 3 shows the result.

### Reference Example 8

Similarly to Reference Example 1, the mixture of the distilled water, the Rh particle dispersion, and the ACZ particles was prepared, dried, and baked. While heated to 900° C., the obtained particles were exposed alternately to a stoichiometric air-fuel mixture (air-fuel ratio A/F=14.6) and a lean air-fuel mixture containing excess oxygen (A/F>14.6) with a time ratio of 1:1 at a fixed cycle of time for five hours.

Next, the particles exposed to the air-fuel mixture were observed with a TEM. Based on the TEM image, the particle size distribution of the Rh particles (the initial Rh particles) supported on the ACZ particles was determined. The mean and the standard deviation of the particle size distribution of the initial Rh particles and the weight proportion of the Rh particles in the baked particles were as shown in Table 3.

To the particles exposed to the air-fuel mixture, the CZ-2 particles having the same weight as the exposed particles were added, and were pulverized and mixed in a mortar. 2 g of the obtained powder was weighed and molded into a pellet.

Similarly to Reference Example 1, the exhaust gas purification performance of the pellet after the aging process was evaluated. Table 3 shows the result.

### Reference Example 9

Except that the mixing ratio of the Rh particle dispersion and the ACZ particles was changed, the pellet was manufactured similarly to Reference Example 1. The mean and the standard deviation of the particle size distribution of the initial Rh particles and the weight proportion of the Rh particles in the baked particles were as shown in Table 3.

Similarly to Reference Example 1, the exhaust gas purification performance of the pellet was evaluated. Table 3 shows the result.

### Reference Example 10

Except that the mixing ratio of the Rh particle dispersion and the ACZ particles was changed, the pellet was manufactured similarly to Reference Example 3. The mean and the standard deviation of the particle size distribution of the initial Rh particles and the weight proportion of the Rh particles in the baked particles were as shown in Table 3.

Similarly to Reference Example 1, the exhaust gas purification performance of the pellet was evaluated. Table 3 shows the result.

It was shown that the NOx-T50s in Reference Examples 1 and 4 to 6 in which the means of the particle size distributions of the initial Rh particles were within the ranges from 1.5 nm to 18 nm were lower than NOx-T50s in Reference Examples 2, 3, and 7, and thus the pellets of Reference Examples 1 and 4 to 6 exhibited the higher NOx reducing performance. From the measurement results of the average particle sizes of the Rh particles after the aging process in Reference Examples 1 and 4 and Reference Examples 2 and 3, it was shown that coarsening of the Rh particles during the aging process was controlled more efficiently in Reference Examples 1 and 4 in which the means of the particle size distributions of the initial Rh particles were 1.5 nm or more, than in Reference Examples 2 and 3 in which the means of the particle size distributions of the initial Rh particles were less than 1.5 nm. Accordingly, it is considered that in Reference Examples 1 and 4 to 6 in which the means of the particle size distributions of the initial Rh particles were 1.5 nm or more, the coarsening of the Rh particles was controlled, which resulted in the control of the reduction in specific surface areas of the Rh particles, and therefore the higher NOx reducing performances were obtained. Additionally, it is considered that in Reference Example 7 in which the mean of the particle size distribution of the initial Rh particles was more than 18 nm, since the specific surface area of the Rh particles was small even before the aging process, the NOx reducing performance was inferior.

In Reference Example 8, similarly to Reference Examples 1 and 4 to 6, the mean of the particle size distribution of the initial Rh particles was within the ranges from 1.5 nm to 18 nm, but the standard deviation of the particle size distribution of the initial Rh particles was 1.6 nm or more, which was larger than those of Reference Examples 1 and 4 to 6. This shows that the pellet of Reference Example 8 contained a larger number of fine Rh particles than the pellets of Reference Examples 1 and 4 to 6. It is considered that in Reference Example 8, the fine Rh particles were coarsened during the aging process, which led to the smaller specific surface area of the Rh particles after the aging process than those of Reference Examples 1 and 4 to 6, and as a result, the NOx reducing performance of Reference Example 8 was lower than those of Reference Examples 1 and 4 to 6.

Similarly, the pellet of Reference Example 9 in which the mean of the particle size distribution of the initial Rh particles was within the range from 1.5 nm to 18 nm exhibited the lower NOx-T50 (i.e., higher NOx reducing performance) than that of the pellet of Reference Example 10 in which the mean of the particle size distribution of the initial Rh particles was less than 1.5 nm. The difference in NOx reducing performance between Reference Example 9 and Reference Example 10 was smaller than the difference in NOx reducing performance between Reference Example 1 and Reference Example 3. This suggests the following. That is, when the weight proportion of the Rh particles in the baked particles is within the range from 0.01 wt % to 2 wt %, especially within the range from 0.2 wt % to 1.8 wt %, the mean of the particle size distribution of the initial Rh particles within the range of 1.5 nm or more can provide the sufficient improvement in NOx reducing performance. However, when the weight proportion of the Rh particles in the baked particles is larger than that (for example, larger than 2 wt %), the mean of the particle size distribution of the initial Rh particles within the range of 1.5 nm or more can not necessarily provide the sufficient improvement in NOx reducing performance.

TABLE 3

| | | Mean of Particle | Standard Deviation | | |
|---|---|---|---|---|---|
| | Proportion of Rh | Size Distribution | of Particle Size | Average Particle | |
| | Particles in Baked | of Initial Rh | Distribution of Initial | Size of Rh Particles | NOx-T50 |
| | Particles [wt %] | Particles [nm] | Rh Particles [nm] | after Aging [nm] | [° C.] |
| Reference | 0.2 | 6.17 | 0.89 | 9.01 | 295.7 |
| Example 1 | | | | | |
| Reference | 0.2 | 0.70 | 0.41 | 12.41 | 345.1 |
| Example 2 | | | | | |
| Reference | 0.2 | 1.42 | 0.48 | 10.82 | 329.1 |
| Example 3 | | | | | |
| Reference | 0.2 | 4.20 | 0.74 | 9.39 | 308.1 |
| Example 4 | | | | | |
| Reference | 0.2 | 13.16 | 1.31 | | 302.7 |
| Example 5 | | | | | |
| Reference | 0.2 | 16.81 | 1.53 | | 322.4 |
| Example 6 | | | | | |
| Reference | 0.2 | 19.10 | 1.55 | | 331.3 |
| Example 7 | | | | | |
| Reference | 0.2 | 5.64 | 1.61 | | 332.5 |
| Example 8 | | | | | |
| Reference | 1.8 | 6.31 | 0.94 | | 235.6 |
| Example 9 | | | | | |
| Reference | 1.8 | 1.48 | 0.51 | | 237.4 |
| Example 10 | | | | | |

What is claimed is:

1. A method for producing an exhaust gas purification material, the method comprising the steps, in this order, of:
(a) impregnating a metal oxide carrier with a rhodium compound solution;
(b) drying the metal oxide carrier impregnated with the rhodium compound solution to obtain a rhodium-containing catalyst containing the metal oxide carrier and rhodium particles supported on the metal oxide carrier;
(c) heating the rhodium-containing catalyst at a temperature within a range from 700° C. to 900° C. under an inert atmosphere; and
(d) mixing the rhodium-containing catalyst with a material having a basicity higher than a basicity of the metal oxide carrier.

2. The method according to claim 1,
wherein in the rhodium-containing catalyst after the step (c), a mean of a particle size distribution of the rhodium particles is from 1.5 nm to 18 nm and a standard deviation of the particle size distribution of the rhodium particles is less than 1.6 nm.

3. The method according to claim 2,
wherein in the rhodium-containing catalyst after the step (c), the mean of the particle size distribution of the rhodium particles is from 4 nm to 14 nm.

4. The method according to claim 2,
wherein in the rhodium-containing catalyst after the step (c), the mean of the particle size distribution of the rhodium particles is from 2 nm to 8 nm.

5. The method according to claim 1,
wherein the rhodium-containing catalyst contains the rhodium particles in an amount of 0.01 wt % to 2 wt % based on a total weight of the metal oxide carrier and the rhodium particles.

6. The method according to claim 1,
wherein the metal oxide carrier is an oxide containing zirconia as a main component, a composite oxide containing zirconia and alumina as main components, or a composite oxide containing zirconia, alumina, and ceria as main components.

7. The method according to claim 1,
wherein the metal oxide carrier is a composite oxide containing zirconia, alumina, and ceria as main components, and the material having the basicity higher than the basicity of the metal oxide carrier is a composite oxide containing ceria and zirconia as main components.

8. The method according to claim 1,
wherein the inert atmosphere is a nitrogen atmosphere.

9. A method for manufacturing an exhaust gas purification device, the method comprising:
obtaining the exhaust gas purification material by the method according to claim 1; and
disposing the exhaust gas purification material on a substrate.
